(19) United States
(12) Patent Application Publication
(10) Pub. No.: US 2020/0334996 A1
(43) Pub. Date: Oct. 22, 2020

(54) System and Method for Handling Terrain in Detect and Avoid

(71) Applicant: The Boeing Company, Chicago, IL (US)

(72) Inventor: Regina Inez Estkowski, Bellevue, WA (US)

(21) Appl. No.: 16/387,741

(22) Filed: Apr. 18, 2019

(51) Int. Cl. G08G 5/04; G08G 5/00

(52) U.S. Cl. CPC G08G 5/045; G08G 5/0086; G08G 5/0021; G08G 5/0039; G08G 5/0078

(57) ABSTRACT

Object detection and avoidance comprising receiving time-referenced position and state data for vehicles, including a control vehicle, within a specified time-space zone, wherein the vehicles have initial positions within the specified time-space zone. Terrain data is received for a spatial zone of interest that overlaps the time-space zone. A trajectory window is calculated for each vehicle within the time-space zone, as well as spatial buffer zones around terrain in the spatial zone of interest according to data uncertainty and resolution. A number of homotopically distinct paths are calculated for the control vehicle from a time-referenced initial position to a destination point, wherein the paths keep the control vehicle at least a minimum specified distance from the trajectory windows of other vehicles and the buffer zones of terrain and obstacles. The control vehicle is then routed according to one of the paths.

### BACKGROUND INFORMATION

### 1. Field

The present disclosure relates generally to routing of vehicles to maintain separation of vehicles and to avoid obstacles. More particularly, the present disclosure relates to the automated integration of terrain and obstacle avoidance in vehicle separation.

### 2. Background

Remain Well Clear is required for the integration of unmanned aircraft systems (UAS) into the National Airspace System (NAS). In particular, terrain and stationary obstacle avoidance while maintaining separation from other vehicle is of major concern for operations at lower altitudes such as operations in urban areas or for infrastructure inspection.

Aircraft and other vehicles in motion may encounter many moving and stationary obstacles. Moving obstacles include other aircraft, flocks of birds, and weather systems. Stationary obstacles include natural objects, such as terrain, and man-made objects, such as towers and buildings. An aircraft moving along its flight path may be required to carry out transitory course modifications due to expected and unexpected obstacles. The operator of the aircraft may seek to execute heading changes that maintain adherence to scheduled arrival time while observing constraints regarding speed, altitude, safety, and passenger comfort.

In addition to other aircraft, the operator of the aircraft might also have to account for terrain and fixed obstacles.

### SUMMARY

An illustrative embodiment provides for a computer-implemented method for object avoidance. The method comprises receiving time-referenced position and state data for vehicles, including a control vehicle, within a specified time-space zone, wherein the vehicles have initial positions within the specified time-space zone. Terrain and obstacle data are received for a spatial zone of interest, wherein a portion of the spatial zone of interest overlaps with a portion of the specified time-space zone. A probabilistic trajectory window is calculated for each vehicle within the specified time-space zone. Spatial buffer zones are calculated around terrain and obstacles in the spatial zone of interest according to terrain and obstacle data uncertainty and resolution. A number of homotopically distinct paths are then calculated for the control vehicle from a time-referenced initial position to a destination point, wherein the paths keep the control vehicle at least a minimum specified distance from the trajectory windows of other vehicles and the buffer zones of terrain and obstacles. The control vehicle is then routed according to one of the paths.

Another illustrative embodiment provides an object avoidance system that comprises a control vehicle and a computer connected to the control vehicle. The computer comprises a bus system, a storage device connected to the bus system, wherein the storage device stores program instructions, and a number of processors connected to the bus system, wherein the number of processors execute the program instructions to: receive time-referenced position and state data for vehicles, including the control vehicle, within a specified time-space zone, wherein the vehicles have initial positions within the specified time-space zone; receive terrain and obstacle data for a spatial zone of interest, wherein a portion of the spatial zone of interest overlaps with a portion of the specified time-space zone; calculate a probabilistic trajectory window for each vehicle within the specified time-space zone; calculate spatial buffer zones around terrain and obstacles in the spatial zone of interest according to terrain and obstacle data uncertainty and resolution; calculate a number of homotopically distinct paths for the control vehicle from a time-referenced initial position to a destination point, wherein the paths keep the control vehicle at least a minimum specified distance from the trajectory windows of other vehicles and the buffer zones of terrain and obstacles; and route the control vehicle according to one of the paths.

Another illustrative embodiment provides a computer program product for object avoidance. The computer program product comprises a non-volatile computer readable storage medium having program instructions embodied therewith, the program instructions executable by a number of processors to cause the computer to perform the steps of: receiving time-referenced position and state data for vehicles, including a control vehicle, within a specified time-space zone, wherein the vehicles have initial positions within the specified time-space zone; receiving terrain and obstacle data for a spatial zone of interest, wherein a portion of the spatial zone of interest overlaps with a portion of the specified time-space zone; calculating a probabilistic trajectory window for each vehicle within the specified time-space zone; calculating spatial buffer zones around terrain and obstacles in the spatial zone of interest according to terrain and obstacle data uncertainty and resolution; calculating a number of homotopically distinct paths for the control vehicle from a time-referenced initial position to a destination point, wherein the paths keep the control vehicle at least a minimum specified distance from the trajectory windows of other vehicles and the buffer zones of terrain and obstacles; and routing the control vehicle according to one of the paths.

The features, functions, and benefits may be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a block diagram of a system of routing decisions in a separation management system in accordance with illustrative embodiments;

FIG. 2 is a diagram providing a schematic view of safe separation windows for aircraft with varying degrees of uncertainty in accordance with illustrative embodiments;

FIGS. 3A and 3B are diagrams providing a schematic view of safe separation windows for terrain with varying degrees of uncertainty according to illustrative embodiments;

FIG. 4 is a block diagram depicting a system for terrain handling and detect and avoid (DAA) in accordance with illustrative embodiments;

FIG. 5 is a diagram depicting a VPR coordinate system superimposed on a projection of a space partition coordinate system in accordance with illustrative embodiments;

FIG. 6 depicts a portion of a single resolution space partition in accordance with an illustrative embodiment;

FIG. 7 depicts a multi-resolution space partition in accordance with an illustrative embodiment;

FIG. 8 depicts multiple layers of a 4D VPR in accordance with an illustrative embodiment;

FIG. 9 is a diagram of a virtual predictive radar displaying fat paths in accordance with illustrative embodiments;

FIG. 10 is a diagram of a virtual predictive radar displaying fat paths in combination with terrain data in accordance with an illustrative embodiment;

FIG. 11 is a diagram of a virtual predictive radar displaying altered fat paths to account for terrain data in accordance with an illustrative embodiment;

FIG. 12 is a flowchart depicting a process flow for integrating terrain information into VPR object avoidance in accordance with an illustrative embodiment;

FIG. 13 is a flowchart depicting a process flow for integrating terrain information into VPR fat paths in accordance with an illustrative embodiment;

FIGS. 14A and 14B are a flowchart illustrating a process for mapping terrain data to a VPR in accordance with illustrative embodiments; and

FIG. 15 is an illustration of a data processing system, in accordance with an illustrative embodiment.

### DETAILED DESCRIPTION

The illustrative embodiments recognize and take into account that terrain and obstacle avoidance while maintaining separation from other vehicles becomes more important for operations at lower altitudes and in particular in the Urban Air Mobility environment.

The illustrative embodiments recognize and take into account the need for a control vehicle, for example an aircraft, to be provided navigation and heading information in advance of reaching decision points.

The illustrative embodiments recognize and take into account that along an aircraft flight path, objects of interest may lie between the aircraft and points ahead of the aircraft along an intended flight path of the aircraft.

An aircraft may follow at least one homotopically distinct region of travel, referred to herein as a “fat path.” A plurality of fat paths may be calculated between a time-referenced initial position of an aircraft and destination point based on maneuvering characteristics of the aircraft and a probabilistic zone of interest for other aircraft. A separation management system receives and filters aircraft and airspace information about a control aircraft and other aircraft the control aircraft seeks to avoid. Trajectory windows for each aircraft can be determined and monitored with respect to time and probable location. The separation management system determines when trajectory overlap might occur and can reroute the control vehicle.

A virtual predictive radar (VPR) screen can display a plurality of trajectory paths for a control vehicle and can include time rings predicting the location of the control vehicle in three-dimensional space plus time. Based on maneuverability characteristics and speed of the control vehicle, constraints may be placed on the control vehicle. When a second vehicle is predicted to intersect the VPR, multiple fat paths can be generated along a subset of the trajectory paths to maintain separation of the control vehicle from the second vehicle.

Homotopically distinct regions of travel (fat paths), separation management systems, virtual predictive radar, and their supporting methods and systems are described in further detail in “Automated Separation Manager”, U.S. Pat. No. 8,060,295 dated Nov. 15, 2011.

The illustrative embodiments recognize and take into account that methods of calculating fat paths for aircraft take into account other aircraft within time-referenced airspace around the control aircraft but do not address handling terrain and ground obstacles in generating routing options.

The illustrative embodiments recognize and take into account that a VPR Maneuver Manifold provides a control vehicle centric representation of traffic information in terms of location relative to the control vehicle, whereas terrain data is typically represented in a global manner such as elevation at latitude, longitude grid points. Therefore, methods that integrate the terrain and vehicle information that may be represented in dissimilar coordinates or maintained in dissimilar data structures are needed in providing simultaneous separation from terrain, obstacles and traffic.

The illustrative embodiments provide a method and system for the inclusion of terrain and obstacle consideration in the VPR data structure for separation management and object avoidance. Terrain data is maintained in a space partition data structure, such as an octree or a rectangular 3D grid-like structure, which is mapped to the VPR data structure. The Maneuver Manifold is also mapped into the terrain representation, and locations where the terrain intersects the maneuver manifold are determined.

The illustrative embodiments provide an automated separation system that maintains a maneuver manifold in the form of a VPR for a control vehicle that continually monitors relevant traffic location in a space-time zone, representing the traffic in the VPR. The separation management system includes an octree module to maintain terrain and obstacle information in a space partition data structure, the extent of which encompasses the space-time zone. The separation management system maps the VPR into the space partition containing terrain and obstacle information, thereby encoding the terrain and obstacle locations in the VPR along with traffic information. The separation management system generates a plurality of fat-paths in the VPR that avoids traffic, terrain, and obstacles such as buildings or towers.

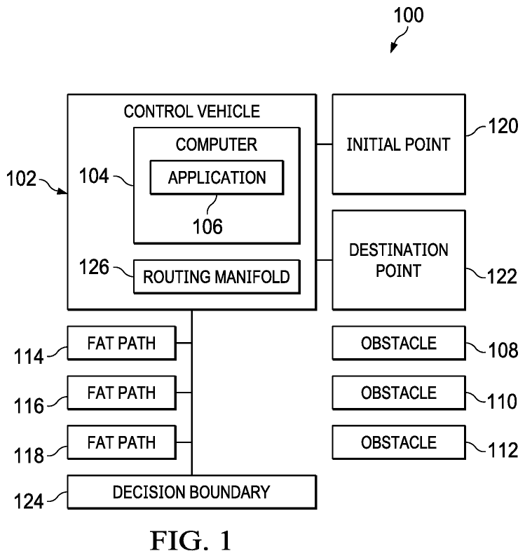

Attention is now turned to the figures. FIG. 1 is an illustration of a block diagram of a system 100 of routing decisions in a separation management system. System 100 includes control vehicle 102, computer 104, application 106, obstacle 108, obstacle 110, obstacle 112, fat path 114, fat path 116, fat path 118, origination point 120, destination point 122, decision boundary 124, and routing manifold 126.

Control vehicle 102 can be an aircraft including fixed wing airplane, helicopter, glider, balloon, blimp, or unmanned aircraft. Control vehicle 102 can also be watercraft including a ship or submarine. Control vehicle 102 can also be a land-based vehicle.

Computer 104 can be a general-purpose computer. Computer 104 can be situated aboard control vehicle 102. Computer 104 can also be situated at a ground location, for example at an air traffic control center. Computer 104 can be multiple computers working together towards a goal, including computers in different physical locations.

Application 106 executes on computer 104 and can execute the actions provided herein regarding setting boundaries in time and space in which operators of control vehicle 102 make decisions regarding headings. In an embodiment, portions of application 106 can execute on more than one computer 104 that may be situated at more than one location or aboard more than one aircraft or other vehicle.

Obstacle 108, obstacle 110, and obstacle 112 may include aircraft, balloons, gliders, unmanned aerial vehicles that may be stationary or in motion. Obstacle 108, obstacle 110, obstacle 112 can also include flocks of birds, weather systems, and any other object either stationary or in motion that control vehicle 102 desires to avoid. Obstacle 108, obstacle 110, and obstacle 112 can also be ground-based and be a natural object such as terrain comprising mountain ranges for example, or may be man-made, for example a communications tower, a building, or a no-fly zone. In maritime embodiments, obstacle 108, obstacle 110, and obstacle 112 can be other ships, submarines, buoys, terrain, both submerged or not, and weather systems.

Fat path 114, fat path 116, and fat path 118 are homotopically distinct regions of travel. Fat path 114, fat path 116, and fat path 118 can be calculated between a time referenced position of control vehicle 102 and a reference point based on maneuvering characteristics of control vehicle 102 and a probabilistic zone of interest for obstacle 108, obstacle 110, and obstacle 112 including other aircraft. Fat path 114, fat path 116, and fat path 118 comprise a maximal simply connected region contained in routing (maneuver) manifold 126 wherein for each point in the region there exists a feasible route for control vehicle 102 that contains the point, that begins at time-referenced initial position 120 and ends at destination point 122. A route for control vehicle 102 is feasible if the route satisfies scheduling requirements and constraints and is physically possible.

Initial position 120, destination point 122, and routing manifold 126 can form a union of possible paths in space and time from a start state to an end state that satisfy maneuver and operational constraints for control vehicle 102 and avoid obstacles 108-112. Maneuver and operational constraints can include speed, altitude, safety, and passenger comfort. Decision boundary 124 is a simply connected set of points in at least one of time and space. In order to maintain a feasible path, upon reaching a point along decision boundary 124, control vehicle 102 must be either on a path that transitions to a fork option including one or more of fat path 114, fat path 116, and fat path 118 or initiate a change of heading onto a different fat path that transitions to one of fat path 114, fat path 116, and fat path 118. It should be noted that the illustrative embodiments can implemented without a decision boundary. A choice of fat path can be made at time 0 with no intention of switching to another fat path, thereby obviating the need for decision boundary 124.

The illustrative embodiments shown in FIG. 1 are not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

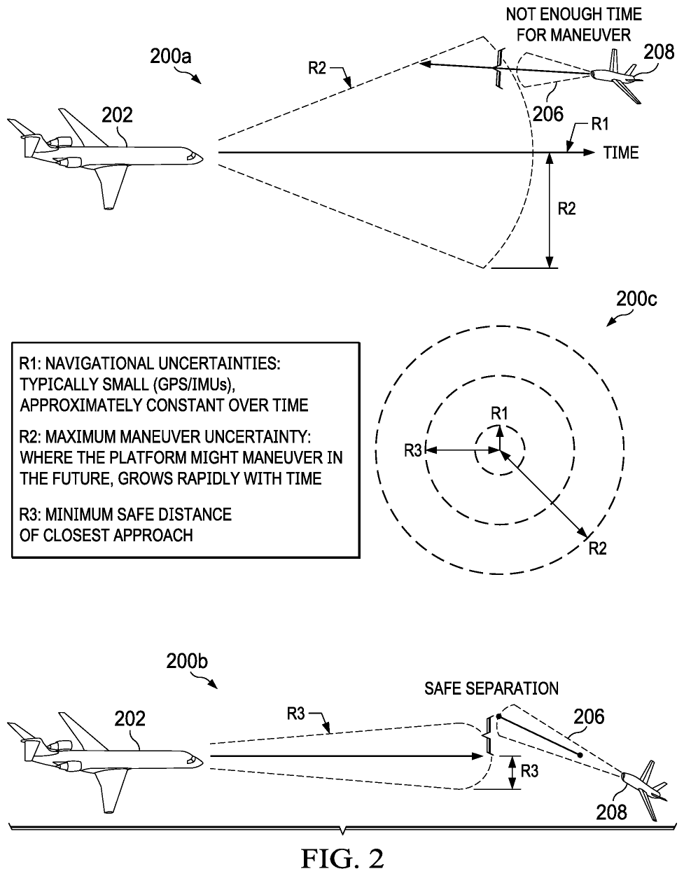

FIG. 2 is a diagram providing a schematic view of safe separation windows for aircraft with varying degrees of uncertainty according to illustrative embodiments. FIG. 2 is provided for illustration purposes and depicts uncertainties to be considered in a separation management system upon which the systems and methods of the present disclosure can be based. Components shown in FIG. 2 are indexed to components shown in FIG. 1. Control aircraft 202 shown in FIG. 2 corresponds to control vehicle 102 shown in FIG. 1. Reference aircraft 208 shown in FIG. 2 corresponds to obstacle 108 shown in FIG. 1. FIG. 2 is a schematic view showing safe separation windows for aircraft with varying degrees of uncertainty.

FIG. 2 depicts two separate scenarios, labeled as 200a and 200b. Control aircraft 202 and reference aircraft 208 each have a trajectory window (probabilistic position zone). The control aircraft 202 has a trajectory window R1 that represents the navigational uncertainty from a planned trajectory path. The trajectory window R1 can result from environmental conditions (e.g., wind, air mass, etc.) instrumentation limitations and/or tolerances, or other factors influencing aircraft trajectory. The navigational uncertainties represented by the subset trajectory window R1 are typically small and may be assumed to be approximately constant over time. A second trajectory window R2 for control aircraft 202 is defined by the possible trajectories of the control aircraft 202 as a function of time, where the radius of R2 represents distance from a straight path. For example, a maneuverable aircraft might have a very large R2 because the aircraft can be able to execute a sharp maneuver in a relatively short distance whereas a less maneuverable aircraft may have a narrower R2 value. Generally speaking, R2 values define the maximum maneuvering uncertainty for an aircraft, and the R2 area characteristically grows rapidly with time.

The reference aircraft 208 also has a trajectory window 206 that defines its probable trajectories and position as a function of time.

Scenario 200a depicts an undesirable situation for control vehicle 202 because trajectory window R2 for control vehicle 202 is too broad such that it does not provide enough room for maneuver to avoid intersection of the respective trajectory windows R2 and 206. Under such conditions, the control aircraft 202 and the reference aircraft 208 might be at a high risk for interference.

The illustrative embodiments reduce the trajectory window control aircraft 202 thereby enlarging the potential separation zones between the control aircraft 202 and the reference aircraft 208.

Scenario 200b depicts conditions of safe separation for control vehicle 202 because trajectory window R3 is narrower such that control vehicle 202 and obstacle 208 will safely pass. Illustrative embodiments use probability curves to reduce the trajectory window R2 to a minimum safe distance trajectory window R3 illustrated in a scenario 200b. For example, trajectory window R3 might represent a ninety-eight percent confidence interval for the trajectory of the control aircraft 202. In contrast to scenario 200a, scenario 200b does not include an intersection of the trajectory window R3 of the control aircraft 202 and trajectory window 206 of the reference aircraft 208, thereby creating a safe separation distance between the two aircraft. The illustrative embodiments use a trajectory window R3 for relevant aircraft when implementing the separation manager to control the airspace.

The different trajectory windows R1, R2, and R3 are further described in section 200c of FIG. 2. As mentioned above, R1 represents small navigational uncertainties typically resulting from environmental conditions, instrumentation limitations and/or tolerances and is approximately constant over time. R2 reflects maximum maneuver uncertainty, representing a look-forward area where the vehicle might maneuver in the future and grows rapidly with project time. R3 represents a minimum safe distance of closest approach. One skilled in the art will appreciate the radius of R1, R2, and R3 may greatly differ from section 200c, although the general relationship of R2 being greater than R3 is consistent.

Referring back to FIG. 1, routing manifold 126 can contain information about regions of uncertainty for pilots, ground control personnel and others, and can also contain information about trajectory windows (e.g., R2, R3) for control vehicle 102 of FIG. 1 and obstacle 108. System 100 also includes decision boundary 124 which provides a simply connected set of points, whereon being reached, operator of control vehicle 102 must make decisions regarding heading while still observing prior established constraints which may include information about regions of uncertainty and trajectory windows.

A virtual predictive radar (VPR) is a data structure that represents a maneuver/routing manifold taking into account the trajectory windows of other aircraft within a look-ahead/time-space zone in front of the control aircraft, as well as the maneuver constraints of the control aircraft.

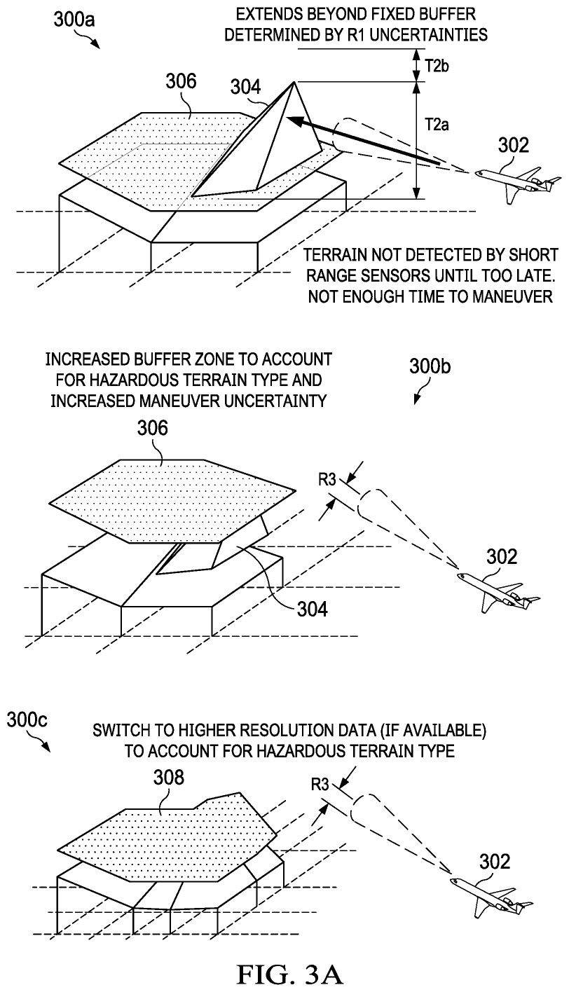

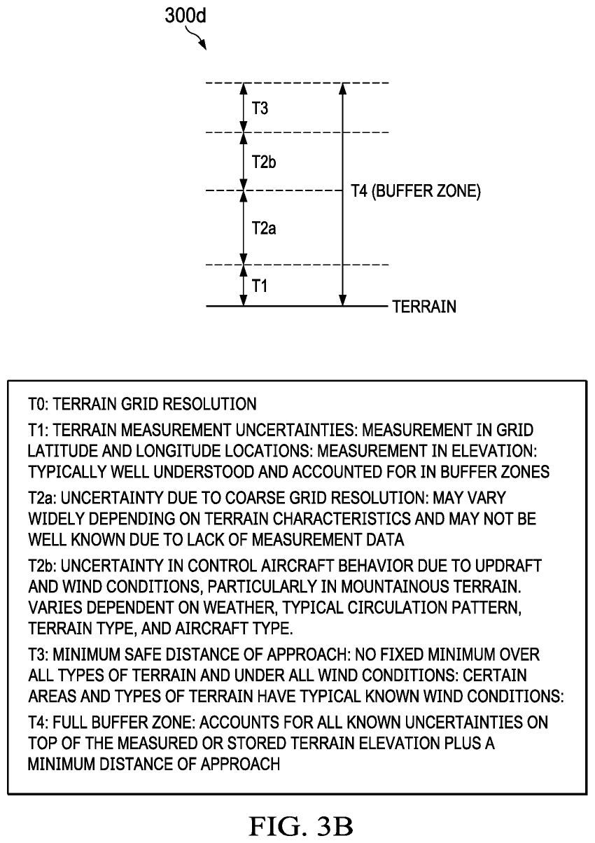

FIGS. 3A and 3B are diagrams providing a schematic view of safe separation windows for terrain with varying degrees of uncertainty according to illustrative embodiments. FIGS. 3A and 3B are provided for illustration purposes and depicts uncertainties to be considered in a terrain avoidance system upon which the systems and methods of the present disclosure can be based. Components shown in FIGS. 3A and 3B are indexed to components shown in FIG. 1. Control aircraft 302 shown in FIG. 2 corresponds to control vehicle 102 shown in FIG. 1. Terrain feature 304 shown in FIG. 3A corresponds to obstacle 108 shown in FIG. 1. FIGS. 3A and 3B are a schematic view showing safe separation windows for terrain with varying degrees of uncertainty.

FIGS. 3A and 3B depict three separate scenarios, labeled as 300a, 300b, and 300c. Maneuver of control aircraft 302 needs to account for T1, which represents terrain measurement uncertainties. Terrain measurement represents grid latitude and longitude locations, and elevation. T1 is typically well understood and accounted for in buffer zone 306.

Maneuver of control aircraft 302 also needs to account for T2a extending beyond the buffer determined by T1 uncertainties. T2a represents uncertainty due to coarse resolution of terrain data and may vary widely depending on terrain characteristics and may not be well known due to lack of measurement data. Terrain feature 304 represents terrain elevation at a spot for which measurement data is not provided due to coarse measurement resolution.

Control aircraft 302 has a trajectory uncertainty T2b that accounts for uncertainty in behavior of control aircraft 302 due to updraft and wind conditions, particularly in mountainous terrain and varies dependent on weather, typical circulation pattern, terrain type, and aircraft type.

The scenario shown in 300a entails the risk that terrain feature 304 is not detected by short range sensors until it is too late for control aircraft 302 to maneuver to avoid it, analogous to reference aircraft 208 in scenario 200a in FIG. 2.

In scenario 300b, trajectory path R3 establishes a minimum safe distance of approach to the buffer zone 306. There is no fixed minimum over all types of terrain under all wind conditions. Certain areas and types of terrain have typical known wind conditions. In Scenario 300b, the buffer zone 306 is increased to account for known wind conditions and terrain types.

In scenario 300c, control aircraft 302 switches to a higher terrain resolution 308, if it is available, to account for hazardous terrain types. The buffer zone is reduced due to increased terrain data resolution but still accounts for wind conditions.

Section 300d of FIG. 3B describes a full buffer zone T4 comprised of uncertainties T1, T2a, T2b associated with terrain along with a minimum safe distance of approach T3 given the terrain type and wind conditions. Scenarios 300b and 300c depict partial buffer zones that do not include T3. It should be understood that the trajectory path R3 at a minimum encompasses T3.

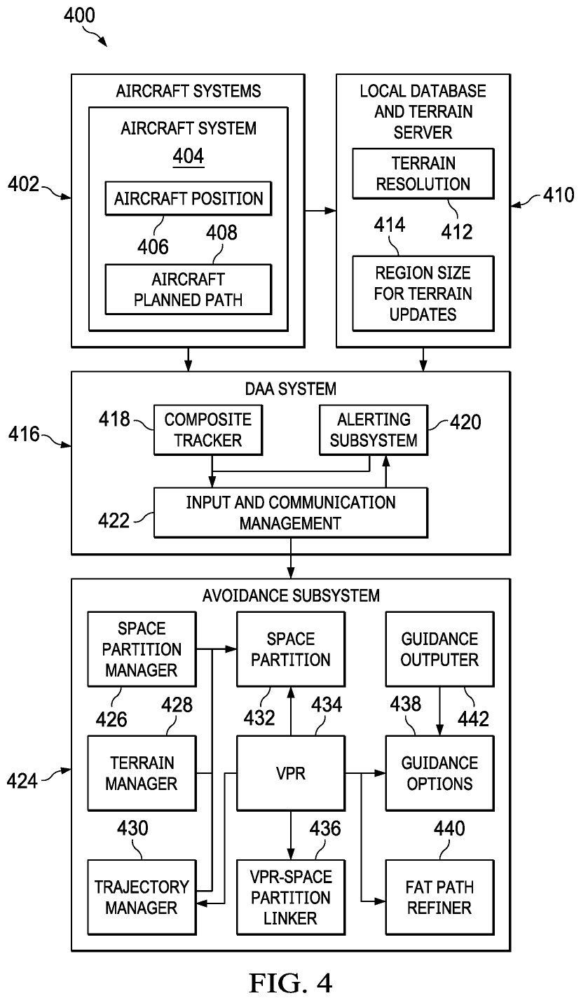

FIG. 4 is a block diagram depicting a system for terrain handling and detect and avoid (DAA) in accordance with illustrative embodiments. System 400 integrates information about aircraft and terrain data within a look-ahead region of a control vehicle. Each aircraft system 404 among aircraft systems 402 has a position 406 and planned path 408, which are available for access by multiple systems.

A local database and/or terrain server 410 provide terrain data and updates given current location, planned path, and parameter-defined local region for updates. An on-board terrain and obstacle database can be included in order to speed up access to terrain and obstacle data. A remote terrain server in communication with the DAA system can also be used in place of or in combination with an onboard database.

Terrain parameters include terrain resolution 412 and regions size for terrain updates 414. Terrain parameters can be updated in real-time or fixed depending on operational need and implementation. The region size for updates 414 is dependent on a specified look-ahead region for terrain, which might be larger than that for intruders (i.e. other vehicles). The look-ahead region depends on ownership speed, allowed deviations from plan, avoidance time frame, and buffer zone beyond the avoidance time frame.

The aircraft and terrain data are fed to DAA system 416, which comprises composite tracker 418, alerting system 420, and input and communications management 422. Input and communications management 422 provides an avoidance subsystem 424 with information related to ownership state, flight plan, terrain, alerts, predicted trajectories and collision avoidance.

Space partition manager 426 maintains space partition parameters. The terrain manager 428 maintains terrain information in the space partition 432. In case of a multi-resolution partition, the terrain manager 432 can decimate or refine received terrain data for representation at various resolutions to be compatible with the resolution of a maneuver manifold of the control vehicles. This can also occur in the case of a single resolution partition in which the received terrain data does not match the partition resolution. The terrain manager 428 also maintains auxiliary data structures, acting as an elevation sorter.

Trajectory manager 430 maintains ownership and intruder predicted trajectories and updates the space partition 432 with predicted trajectories if predicted trajectories are maintain in the partition.

Space partition 432 is a data structure used for efficient representation, maintenance, and access of information where location in a spatial construct is relevant. Space partitions can be used to maintain information on airspace traffic, which is particularly useful in areas of high traffic.

Space partition 432 represents space partition cells, information associated with each partition cell, partition parameters, and structures for efficient partition search, which is often a tree structure. Space partition 432 is used to maintain relevant terrain data and to map the terrain data to the VPR 434.

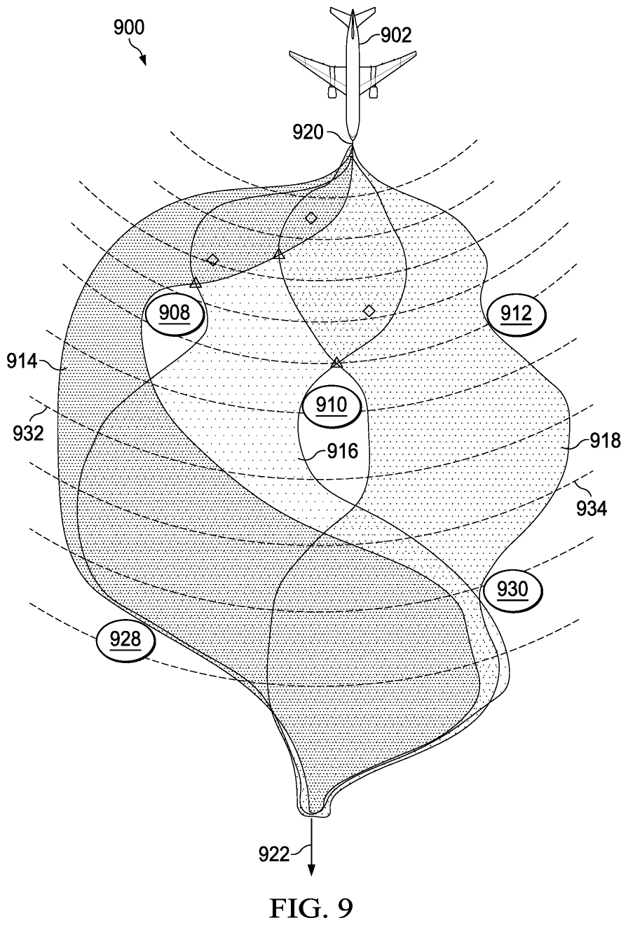

VPR 434 generates VPR data given the ownership predicted trajectory of the control aircraft and represents intruders in the VPR intruded predicted trajectories. From this data, the VPR generates avoidance fat paths, such as pat paths 914, 916, 918 shown in FIG. 9.

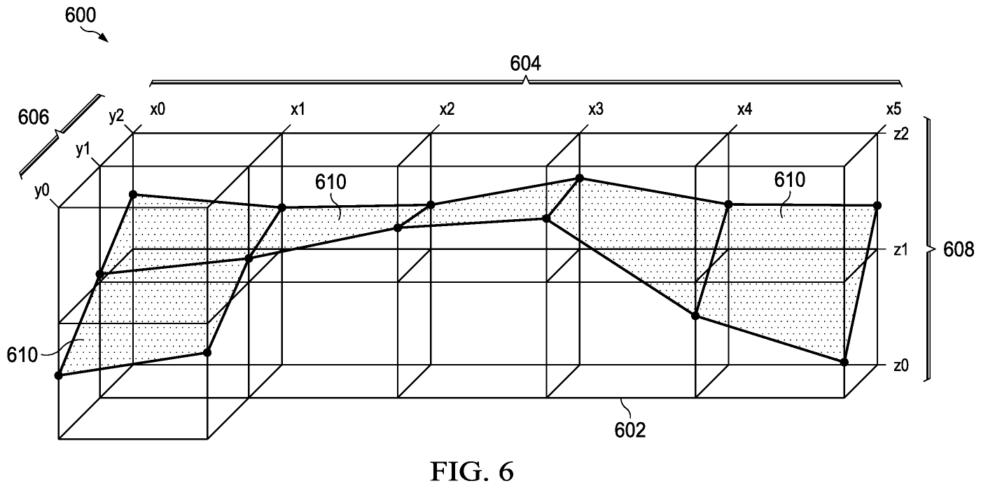

VPR-space partition linker 436 provide the ability to map the space partition 432 into the VPR 434 and vice versa. The VPR 434 provides an ownership-centric representation of airspace in the form of azimuth, range, elevation, and time. The space partition 432 is typically a rectangular representation of terrain based on latitude, longitude, and altitude, as shown for example in FIG. 6. Therefore, the VPR 434 and space partition 432 have different data structures with different coordinate systems. The VPR-space partition linker 436 can map VPR cells into space partition cells or map VPR fat path cells into space partition cells and the elevator sorter.

Fat path refiner 440 refines fat paths given terrain and obstacle data and metrics information and can calculate new fat paths in response to either changes in position and state data of other vehicles or changes in terrain and obstacle data. Guidance options 438 convert fat path information, including rerouting options, into representation for output as well as other representation such as waypoint options/bands. Guidance outputer 442 places the guidance information into the required output format.

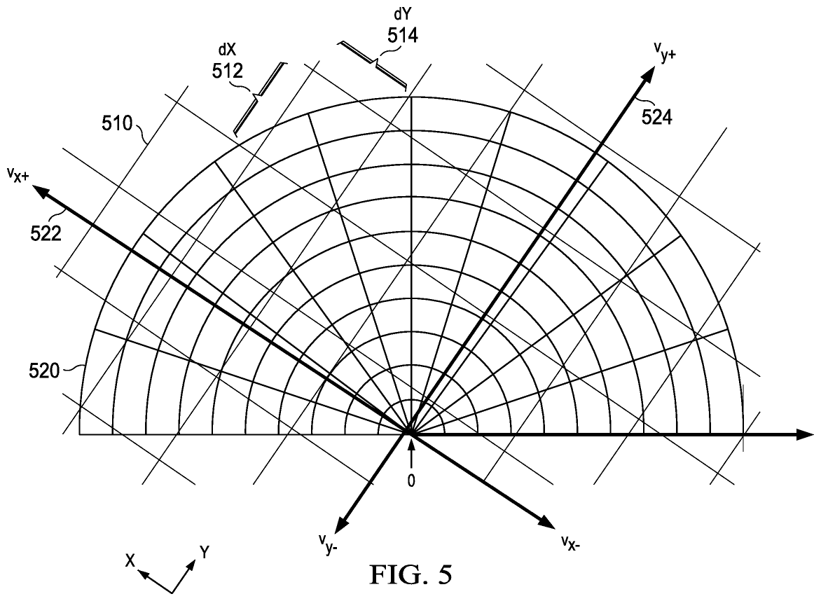

FIG. 5 is a diagram depicting a VPR coordinate system superimposed on a projection of a space partition coordinate system in accordance with illustrative embodiments. Specifically, FIG. 5 illustrates one layer of the VPR coordinate system superimposed over the projected space partition wherein the Z coordinate is constant.

The VPR 520 represents a time-space zone ahead of the control aircraft. The space partition 510 represents a spatial zone of interest that at least partially overlaps with the time-space zone. The portions of the spatial zone of interest and time-space zone that overlap with each other might comprise only sub-sections of each respective zone or the entire zones.

As can be seen in FIG. 5, the space partition 510 takes the form of a rectangular grid in an X-Y plane in this view. Cells in the space partition are defined by a X dimension 512 and a Y dimension 514. The VPR 520 takes the form of a radial grid originating from an initial 0-point, which also represents the position of the control aircraft. The ν_{X} direction vector 522 is located at 0 and points parallel to the X direction of the space partition 510. Similarly, the ν_{Y} direction vector 524 is located at 0 and points parallel to the X direction of the space partition 510.

It should be noted that FIG. 5 depicts a single plane of both the space partition 510 and VPR 520 for ease of illustration. Both the space partition 510 and VPR 520 can comprise multiple layers along the Z axis as explained below.

FIG. 6 depicts a portion of a single resolution space partition in accordance with an illustrative embodiment. Space partition 600 is represented as a rectangular 3D grid-like structure comprising a plurality of cells 602. The cells 602 are defined by respective coordinates along the X 604, Y 606, and Z 608 axes, enabling representation of terrain features 610 in three dimensions within the cells as shown. Terrain data can be provided to the DAA system in a triangulated format in the form of elevation values at regularly-spaced, latitude and longitude X-Y grid points.

The example space partition 600 depicted in FIG. 6 is single resolution wherein only a single size of cell is employed.

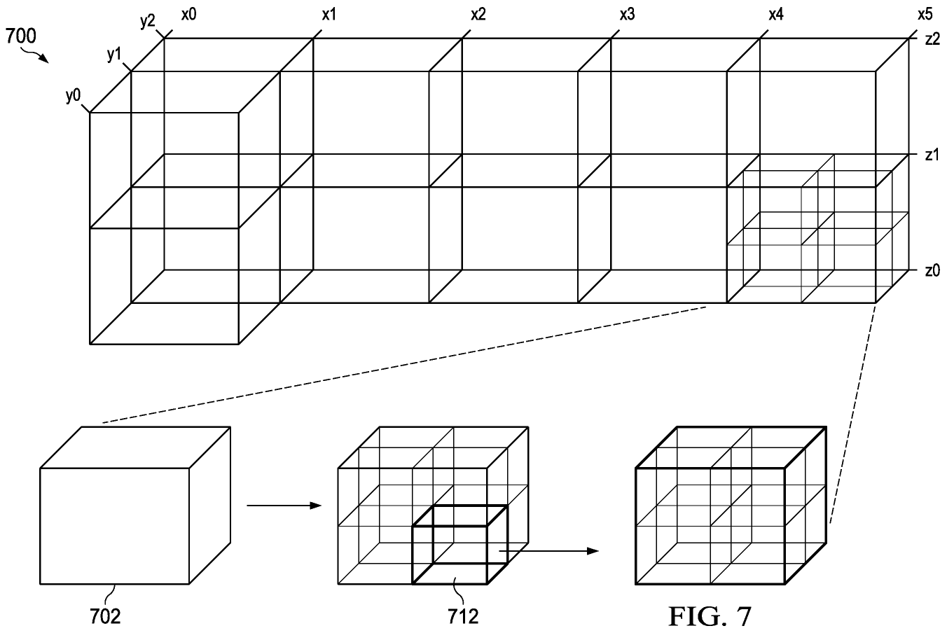

FIG. 7 depicts a portion of a multi-resolution space partition in accordance with an illustrative embodiment. In this example, space partition 700 is represented as an octree in which each cell 702 has eight child cells 712. The parent cells 702 and child cells 712 represent different levels of resolution. As explained below, the degree of terrain data resolution can affect the manner in which it is combined with VPR data.

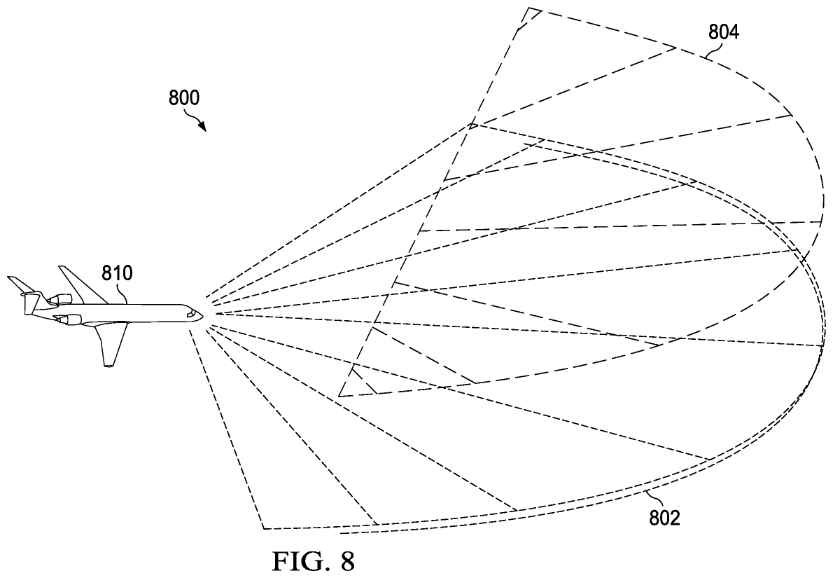

FIG. 8 depicts multiple layers of a four-dimensional (4D) VPR in accordance with an illustrative embodiment. FIG. 8 is a simplified representation for ease of illustration. In this view, 4D VPR 800 comprises two VPR layers 802 and 804. As shown, aircraft 810 is currently traveling at an altitude represented by VPR layer 802. As can be seen in FIG. 8, VPR layer 804 is truncated in comparison to VPR layer 802. This truncation accounts for the horizontal distance aircraft 810 has to cover while climbing to reach the altitude of VPR layer 804.

The illustrative embodiments map the data structures of the space partition and VPR to each other and look for intersections between the data structures. The fat paths represented in the VPR can be optimized or altered according to the presence of terrain features.

FIG. 9 is a diagram of a virtual predictive radar displaying fat paths in accordance with illustrative embodiments. Components shown in FIG. 9 are indexed to components shown in FIG. 1. Control vehicle 902 shown in FIG. 9 corresponds to control vehicle 102 shown in FIG. 1. Obstacle 908, obstacle 910, obstacle 912 shown in FIG. 9 correspond to obstacle 108, obstacle 110, obstacle 112 shown in FIG. 1. Fat path 914, fat path 916, fat path 918 shown in FIG. 9 correspond to fat path 114, fat path 116, fat path 118 shown in FIG. 1. Initial origination point 920 and destination point 922 shown in FIG. 9 correspond to time-referenced initial position 120 and destination point 122, respectively, shown in FIG. 1. FIG. 9 also depicts several components that do not correspond to components depicted in FIG. 1. FIG. 9 depicts two additional obstacles, obstacle 928 and obstacle 930.

4D-VPR 900 also includes time rings, two of which are labeled for discussion purposes, time ring 932 and time ring 934. While depicted in FIG. 9 as a ring, time ring 932 and time ring 934 might not be shaped in a ring-like fashion and can take on various shapes. Probabilities of vehicle arrival at a particular point at a particular time may also be associated with at least one of time ring 932 and time ring 934. Time rings 932, 934 can assume various dimensions in order to reflect uncertainty of location of control vehicle 902 at a given time. Time rings 932, 934 are not components of a system or method per se, but are rather representations of boundaries in time. As control vehicle 902 departs from initial position 920 and moves in the direction of destination point 922, control vehicle 902 crosses boundaries that may be set by application 106 of FIG. 1, including time ring 932 and time ring 934. Time rings 932, 934 can be used in calculating a time until control vehicle 902 would be expected to reach a divergence point of any combination of fat path 914, fat path 916, and fat path 918. Time rings 932, 934 are also useful in determining positions of obstacles 908, 910, 912, particularly if the obstacles are in motion.

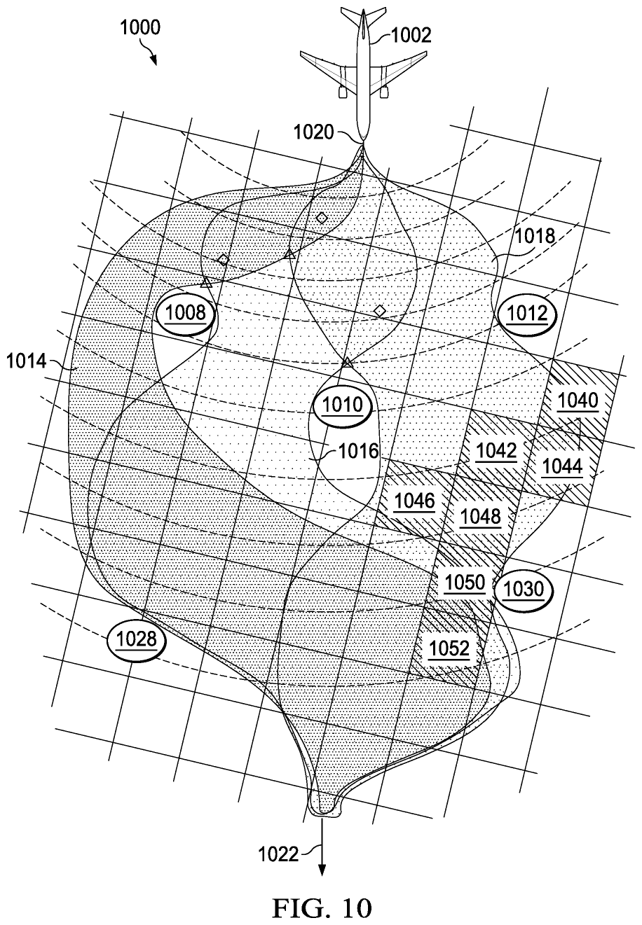

FIG. 10 is a diagram of a virtual predictive radar displaying fat paths in combination with terrain data in accordance with an illustrative embodiment. Similar to VPR 900 in FIG. 9, 4D-VPR 1000 includes three fat paths 1014, 1016, and 1018 that avoid obstacles 1008, 1010, 1012, 1028, and 1030, which are aircraft. VPR 1000 also incorporates terrain data which indicates that terrain features intersect the maneuver manifold in cells 1040, 1042, 1044, 1046, 1048, 1050, and 1052.

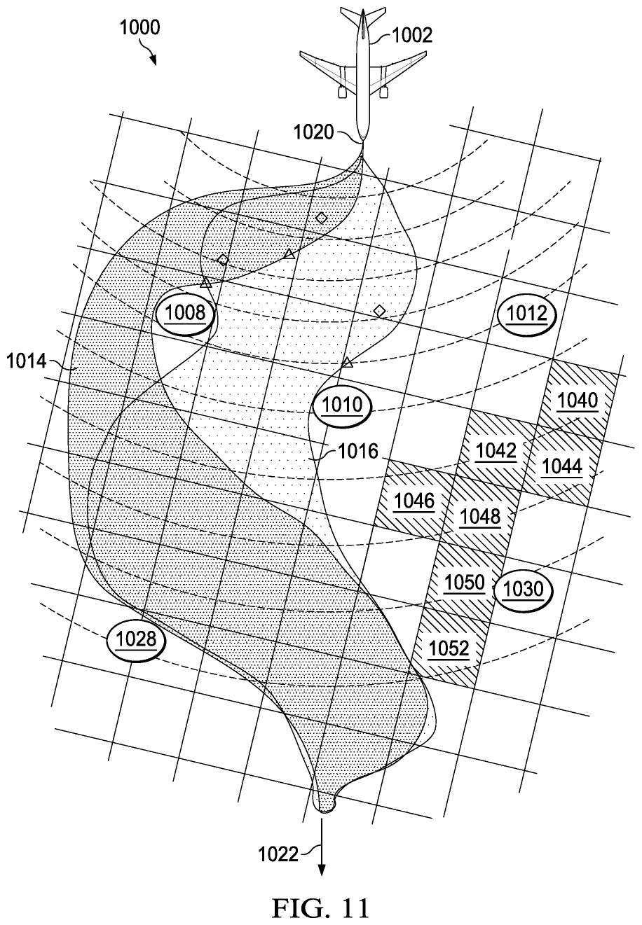

Referring to FIG. 11, fat path 1018 has been removed from VPR 1000 as a result of the presence of terrain obstacles identified in cells 1040-1052, leaving fat paths 1014 and 1016 as the only remaining fat paths for control aircraft 1002 to avoid both the aircraft and terrain obstacles between time-reference initial position 1020 and destination point 1022.

In an illustrative embodiment, the terrain data is mapped to the VPR before calculating the fat paths for the control aircraft. I another illustrative embodiment, the fat paths for the control aircraft are calculated before mapping the terrain data to the VPR and then altered as necessary according to the terrain data. This latter embodiment is more appropriate when the terrain data has a higher resolution than the VPR, in order to reduce processing load.

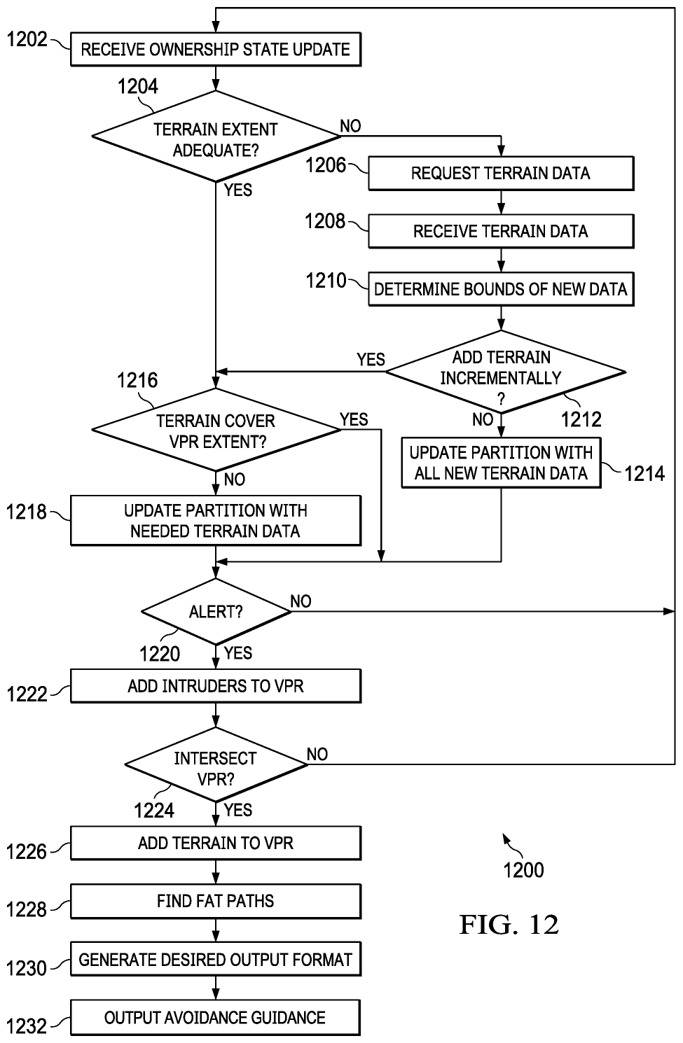

FIG. 12 is a flowchart depicting a process flow for integrating terrain information into VPR object avoidance in accordance with an illustrative embodiment. Process 1200 can be implemented by avoidance subsystem 524 shown in FIG. 5. In process 1200, the terrain data is added to the VPR prior to finding fat paths. This approach is suited for situations in which the terrain data has a lower resolution.

Process 1200 begins by receiving an ownership state update for a control aircraft (step 1202). This can include location and flight plan update, if any. The avoidance subsystem determines if the current terrain extent is adequate (step 1204). If the terrain extent is not adequate, the avoidance system requests terrain information, indicating the extent desired (step 1206). The terrain information is received (step 1208), and the system determines the bounds of new data (step 1210). This might be required in the terrain server provides only predetermined chunks of information, which might include both current and new data.

The system then determines if the mode is set to add terrain information incrementally (step 1212). If the mode is not set to add terrain incrementally, the space partition is updated with all of the new terrain data (step 1214).

If the mode is set to add terrain incrementally, the system then determines if the current partition terrain information cover the potential VPR extent (step 1216). If the terrain information does not cover the VPR extent, the partition is updated with the needed terrain data (step 1218).

The system then determines if there is an intruder alert (step 1220). If there is no intruder alert, the process returns to step 1202 to receive updated ownership state data.

If there is an alert, the system adds the intruders to the VPR (step 1222) and determines if there are intruders that intersect the VPR according to their respective probabilistic trajectory windows (step 1224). If none of the intruders intersect the VPR, the process returns to step 1202.

If intruders intersect the VPR, the avoidance subsystem adds terrain data to the VPR (step 1226). This can be done by mapping space partition cell rows to the VPR as explained in more detail below.

After the terrain data is mapped to the VPR, the avoidance system finds fat paths in the VPR that avoids both intruders and terrain features in the terrain data (step 1228). This is accomplished according to the probabilistic trajectory windows for other aircraft, spatial buffer zones calculated around terrain features and obstacles (based on data uncertainty and resolution), and control vehicle maneuver capabilities and constraints. The fat paths keep the control vehicle at least a minimum specified distance from the trajectory windows of other vehicles and the buffer zones of terrain and obstacles.

After the fat paths are determined the desired output format is generated from the fat path information (step 1230), and the avoidance guidance is output (step 1232).

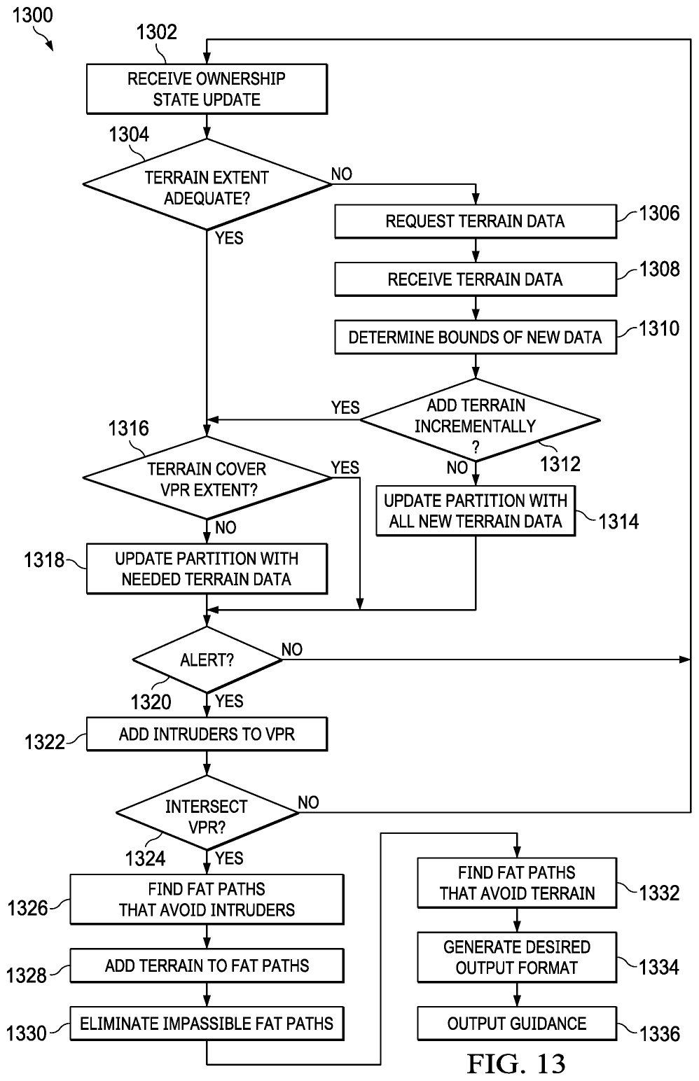

FIG. 13 is a flowchart depicting a process flow for integrating terrain information into VPR fat paths in accordance with an illustrative embodiment. Process 1300 differs from process 1200 in that the fat paths are determined first and then refined as needed to accommodate terrain data. Process 1300 is suited for situations if the terrain is high resolution in order to reduce processing load. This procedure is preferable if the VPR partition is much courser than the terrain partition.

Process 1300 begins by receiving an ownership state update for a control aircraft (step 1302). This can include location and flight plan update, if any. The avoidance subsystem determines if the current terrain extent is adequate (step 1304). If the terrain extent is not adequate, the avoidance system requests terrain information, indicating the extent desired (step 1306). The terrain information is received (step 1308), and the system determines the bounds of new data (step 1310). This might be required in the terrain server provides only predetermined chunks of information, which might include both current and new data.

The system then determines if the mode is set to add terrain information incrementally (step 1312). If the mode is not set to add terrain incrementally, the space partition is updated with all of the new terrain data (step 1314).

If the mode is set to add terrain incrementally, the system then determines if the current partition terrain information cover the potential VPR extent (step 1316). If the terrain information does not cover the VPR extent, the partition is updated with the needed terrain data (step 1318).

The system then determines if there is an intruder alert (step 1320). If there is no intruder alert, the process returns to step 1302 to receive updated ownership state data.

If there is an alert, the system adds the intruders to the VPR (step 1322) and determines if there are intruders that intersect the VPR (step 1324). If none of the intruders intersect the VPR, the process returns to step 1302.

If there are intruders that intersect the VPR the avoidance subsystem first finds fat paths in the VPR that avoid intruders (step 1326). After the fat paths are determined, the system adds terrain data to the fat paths (step 1328). This can be done by mapping the VPR cells to the space partition.

If a path is blocked by terrain at any stage, the system marks it as impassible and moves to the next path (step 1330). The system finds fat paths that avoid terrain within the existing fat paths (step 1332). After the passable fat paths are determined the desired output format is generated from the fat path information (step 1330), and the avoidance guidance is output (step 1336).

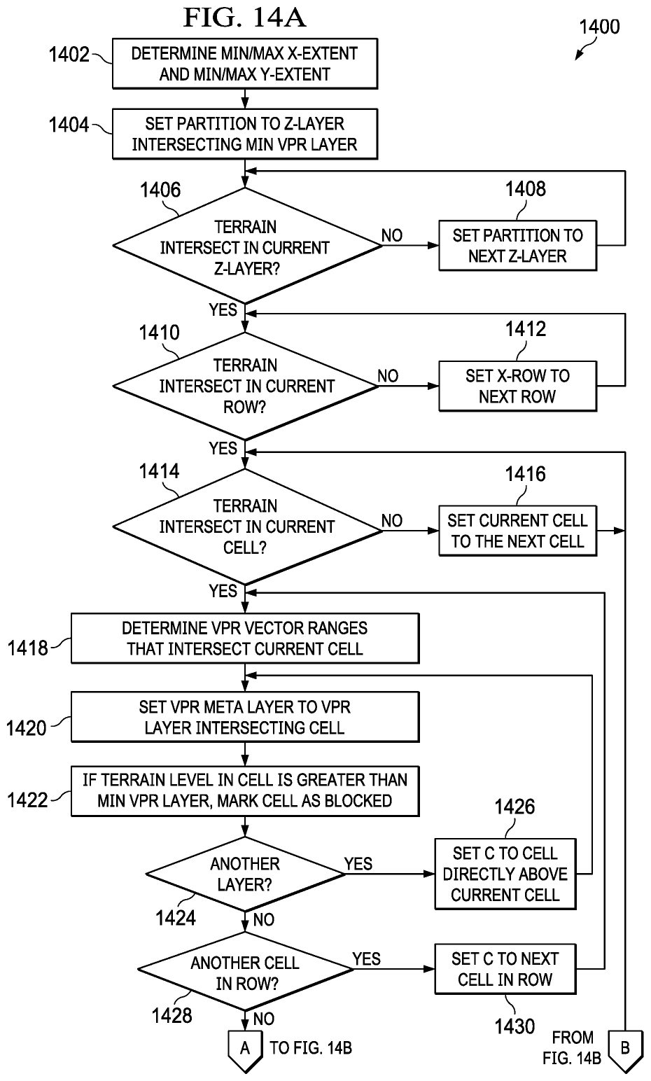

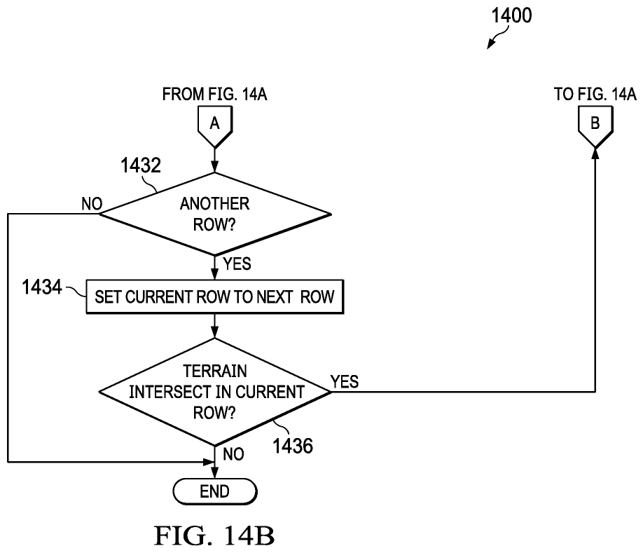

FIGS. 14A and 143 are a flowchart illustrating a process for mapping terrain data to a VPR in accordance with illustrative embodiments. Process 1400 maps the terrain data to the VPR and vice versa by finding intersections between the respective data structures. Process 1400 begins by determining the min/max of the X-extent and min/max of the Y-extent in the space partition, which defines the extent of the space partition included in the look-forward region in ahead of the control aircraft (step 1402). Process 1400 can proceed using either the X-rows or Y-rows in the partition. The present example assumes use of the X-rows.

Next the partition current Z-layer value is set to the layer intersection the min VPR layer (step 1404), and a determination is made if there is a possible terrain intersection in the current Z-layer (step 1406). If there is no possible intersection, the process sets the current Z-layer value to the next Z-layer (step 1408) and checked for terrain intersection.

If there is a possible terrain intersection in a current Z-layer, the process sets the current X-row value to the row intersection the min Y-extent and determines if there is a possible terrain intersection in the current row (step 1410). If there is no intersection, the current X-row value is set to the next row (step 1412), and again checked for a possible terrain intersection.

If a possible terrain intersection is found with the current X-row, the process then sets the current cell value C to the row-cell intersecting the min X-extent in that Z-layer and determines if there is a possible terrain intersection with that cell (step 1414). If no intersection is found, C is set to the next cell in the X-row (step 1416), which is then checked for terrain intersection.

If a possible terrain intersection is detected for the current cell C, the process then determines the VPR vector ranges (defined by range R and angle θ) that intersect the current X-Y dimensions of C (step 1418).

The current VPR-meta layer value is set to the VPR layer intersecting current cell C (step 1420). For each VPR cell (R, θ) intersecting C, if the maximum terrain level (plus a buffer zone) is equal to or greater than the min VPR layer, that VPR cell is marked blocked (step 1422).

The process then determines if there is another partition Z-layer above the one with the intersection (step 1424). If there is another Z-layer, C is set to the cell directly above the current one (step 1426) and the VPR layer is adjusted upward again (step 1420). In essence, when a terrain intersection is found in a cell, process 1400 determines how high the terrain feature goes until the airspace is clear.

If there are no more space partition layers, process 1400 determines if there is another cell in the same X-row (step 1428). If there is another cell, the value C is set for the next cell in the X-row (step 1430), and the VPR ranges that intersect that cell are again determined (step 1418).

If there are no more cells in the X-row, process 1400 determines if there is another row in that Z-layer (step 1432). If there are no more rows, the process ends.

If there is another row, the current row value is set to the next row (step 1434), and this next row is checked for a possible terrain intersection (step 1436). If there is no terrain intersection in the row, the process ends.

If there is a possible terrain intersection in the next row, process 1400 returns to step 1414 and sets the current cell C to the cell intersection the min X-extent and determines if there is a terrain intersection with that cell. Process 1400 continues until no terrain intersections are found in the specified look-ahead region.

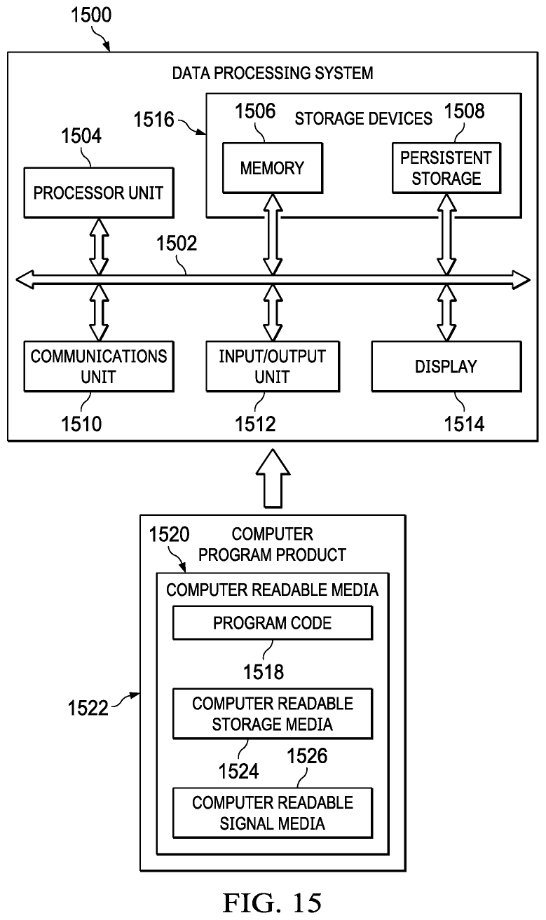

Turning now to FIG. 15, an illustration of a data processing system is depicted in accordance with an illustrative embodiment. Data processing system 1500 in FIG. 15 is an example of a data processing system that may be used to implement the illustrative embodiments, such as computer 104 of FIG. 1, or any other module or system or process disclosed herein. In this illustrative example, data processing system 1500 includes communications fabric 1502, which provides communications between processor unit 1504, memory 1506, persistent storage 1508, communications unit 1510, input/output (I/O) unit 1512, and display 1514.

Processor unit 1504 serves to execute instructions for software that may be loaded into memory 1506. Processor unit 1504 may be a number of processors, a multi-processor core, or some other type of processor, depending on the particular implementation. A number, as used herein with reference to an item, means one or more items. Further, processor unit 1504 may be implemented using a number of heterogeneous processor systems in which a main processor is present with secondary processors on a single chip. As another illustrative example, processor unit 1504 may be a symmetric multi-processor system containing multiple processors of the same type.

Memory 1506 and persistent storage 1508 are examples of storage devices 1516. A storage device is any piece of hardware that is capable of storing information, such as, for example, without limitation, data, program code in functional form, and/or other suitable information either on a temporary basis and/or a permanent basis. Storage devices 1516 may also be referred to as computer readable storage devices in these examples. Memory 1506, in these examples, may be, for example, a random access memory or any other suitable volatile or non-volatile storage device. Persistent storage 1508 may take various forms, depending on the particular implementation.

For example, persistent storage 1508 may contain one or more components or devices. For example, persistent storage 1508 may be a hard drive, a flash memory, a rewritable optical disk, a rewritable magnetic tape, or some combination of the above. The media used by persistent storage 1508 also may be removable. For example, a removable hard drive may be used for persistent storage 1508.

Communications unit 1510, in these examples, provides for communications with other data processing systems or devices. In these examples, communications unit 1510 is a network interface card. Communications unit 1510 may provide communications through the use of either or both physical and wireless communications links.

Input/output (I/O) unit 1512 allows for input and output of data with other devices that may be connected to data processing system 1500. For example, input/output (I/O) unit 1512 may provide a connection for user input through a keyboard, a mouse, and/or some other suitable input device. Further, input/output (I/O) unit 1512 may send output to a printer. Display 1514 provides a mechanism to display information to a user.

Instructions for the operating system, applications, and/or programs may be located in storage devices 1516, which are in communication with processor unit 1504 through communications fabric 1502. In these illustrative examples, the instructions are in a functional form on persistent storage 1508. These instructions may be loaded into memory 1506 for execution by processor unit 1504. The processes of the different embodiments may be performed by processor unit 1504 using computer implemented instructions, which may be located in a memory, such as memory 1506.

These instructions are referred to as program code, computer usable program code, or computer readable program code that may be read and executed by a processor in processor unit 1504. The program code in the different embodiments may be embodied on different physical or computer readable storage media, such as memory 1506 or persistent storage 1508.

Program code 1518 is located in a functional form on computer readable media 1520 that is selectively removable and may be loaded onto or transferred to data processing system 1500 for execution by processor unit 1504. Program code 1518 and computer readable media 1520 form computer program product 1522 in these examples. In one example, computer readable media 1520 may be computer readable storage media 1524 or computer readable signal media 1526. Computer readable storage media 1524 may include, for example, an optical or magnetic disk that is inserted or placed into a drive or other device that is part of persistent storage 1508 for transfer onto a storage device, such as a hard drive, that is part of persistent storage 1508. Computer readable storage media 1524 also may take the form of a persistent storage, such as a hard drive, a thumb drive, or a flash memory, that is connected to data processing system 1500. In some instances, computer readable storage media 1524 may not be removable from data processing system 1500.

Alternatively, program code 1518 may be transferred to data processing system 1500 using computer readable signal media 1526. Computer readable signal media 1526 may be, for example, a propagated data signal containing program code 1518. For example, computer readable signal media 1526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1518 may be downloaded over a network to persistent storage 1508 from another device or data processing system through computer readable signal media 1526 for use within data processing system 1500. For instance, program code stored in a computer readable storage medium in a server data processing system may be downloaded over a network from the server to data processing system 1500. The data processing system providing program code 1518 may be a server computer, a client computer, or some other device capable of storing and transmitting program code 1518.

The different components illustrated for data processing system 1500 are not meant to provide architectural limitations to the manner in which different embodiments may be implemented. The different illustrative embodiments may be implemented in a data processing system including components in addition to or in place of those illustrated for data processing system 1500. Other components shown in FIG. 15 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1504 may take the form of a hardware unit that has circuits that are manufactured or configured for a particular use. This type of hardware may perform operations without needing program code to be loaded into a memory from a storage device to be configured to perform the operations.

For example, when processor unit 1504 takes the form of a hardware unit, processor unit 1504 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 1518 may be omitted because the processes for the different embodiments are implemented in a hardware unit.

In still another illustrative example, processor unit 1504 may be implemented using a combination of processors found in computers and hardware units. Processor unit 1504 may have a number of hardware units and a number of processors that are configured to run program code 1518. With this depicted example, some of the processes may be implemented in the number of hardware units, while other processes may be implemented in the number of processors.

As another example, a storage device in data processing system 1500 is any hardware apparatus that may store data. Memory 1505, persistent storage 1508, and computer readable media 1520 are examples of storage devices in a tangible form.

In another example, a bus system may be used to implement communications fabric 1502 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 1505, or a cache, such as found in an interface and memory controller hub that may be present in communications fabric 1502.

Data processing system 1500 may also include associative memory 1528. Associative memory 1528 may be in communication with communications fabric 1502. Associative memory 1528 may also be in communication with, or in some illustrative embodiments, be considered part of storage devices 1516. While one associative memory 1528 is shown, additional associative memories may be present.

The different illustrative embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non-limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems or remote printers or storage devices through intervening private or public networks. Non-limiting examples of modems and network adapters are just a few of the currently available types of communications adapters.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for object avoidance, the method comprising:
receiving, by a number of processors, time-referenced position and state data for vehicles, including a control vehicle, within a specified time-space zone, wherein the vehicles have initial positions within the specified time-space zone;
receiving, by a number of processors, terrain and obstacle data for a spatial zone of interest, wherein a portion of the spatial zone of interest overlaps with a portion of the specified time-space zone;
calculating, by a number of processors, a probabilistic trajectory window for each vehicle within the specified time-space zone;
calculating, by a number of processors, spatial buffer zones around terrain and obstacles in the spatial zone of interest according to terrain and obstacle data uncertainty and resolution;
calculating, by a number of processors, a number of homotopically distinct paths for the control vehicle from a time-referenced initial position to a destination point, wherein the paths keep the control vehicle at least a minimum specified distance from the trajectory windows of other vehicles and the buffer zones of terrain and obstacles; and
routing the control vehicle, by a number of processors, according to one of the paths.

2. The method of claim 1, wherein the homotopically distinct paths are calculated according to maneuver capabilities and constraints of the control vehicle.

3. The method of claim 1, further comprising:
calculating, by a number of processors, a number of new homotopically distinct paths in response to either changes in position and state data of other vehicles or changes in terrain and obstacle data; and
rerouting, by a number of processors, the control vehicle along one of the new paths.

4. The method of claim 1, wherein the terrain and obstacle data are represented in a triangulated format.

5. The method of claim 4, wherein the terrain and obstacle data comprise elevation data at regularly-spaced grid points.

6. The method of claim 1, further comprising displaying the homotopically distinct paths on a four-dimensional virtual predictive radar (4D-VPR).

7. The method of claim 6, wherein the 4D-VPR indicates intersections of vehicles, terrain, and obstacles on time rings.

8. The method of claim 1, further comprising:
generating, by a number of processors, a space partition; and
mapping, by a number of processors, a maneuver manifold for the control vehicle into the space partition.

9. The method of claim 8, further comprising decimating or refining, by a number of processors, terrain and obstacle data resolution to match maneuver manifold resolution.

10. The method of claim 1, wherein the terrain and obstacle data are provided by at least one of a database onboard the control vehicle or an offboard server.

11. An object avoidance system, comprising:
a control vehicle;
a computer connected to the control vehicle, the computer comprising:
a bus system;
a storage device connected to the bus system, wherein the storage device stores program instructions; and
a number of processors connected to the bus system, wherein the number of processors execute the program instructions to:
receive time-referenced position and state data for vehicles, including the control vehicle, within a specified time-space zone, wherein the vehicles have initial positions within the specified time-space zone;
receive terrain and obstacle data for a spatial zone of interest, wherein a portion of the spatial zone of interest overlaps with a portion of the specified time-space zone;
calculate a probabilistic trajectory window for each vehicle within the specified time-space zone;
calculate spatial buffer zones around terrain and obstacles in the spatial zone of interest according to terrain and obstacle data uncertainty and resolution;
calculate a number of homotopically distinct paths for the control vehicle from a time-referenced initial position to a destination point, wherein the paths keep the control vehicle at least a minimum specified distance from the trajectory windows of other vehicles and the buffer zones of terrain and obstacles; and
route the control vehicle according to one of the paths.

12. The object avoidance system of claim 11, wherein the homotopically distinct paths are calculated according to maneuver capabilities and constraints of the control vehicle.

13. The object avoidance system of claim 11, wherein the processors further execute program instructions to:
calculate a number of new homotopically distinct paths in response to either changes in position and state data of other vehicles or changes in terrain and obstacle data; and
reroute the control vehicle along one of the new paths.

14. The object avoidance system of claim 11, wherein the terrain and obstacle data are represented in a triangulated format.

15. The object avoidance system of claim 14, wherein the terrain and obstacle data comprise elevation data at regularly-spaced grid points.

16. The object avoidance system of claim 11, further comprising a display system configured to display the homotopically distinct paths on a four-dimensional virtual predictive radar (4D-VPR).

17. The object avoidance system of claim 16, wherein the 4D-VPR indicates intersections of vehicles, terrain, and obstacles on time rings.

18. The object avoidance system of claim 11, wherein the processors further execute program instructions to:
generate a space partition; and
map a maneuver manifold for the control vehicle into the space partition.

19. The object avoidance system of claim 18, wherein the processors further execute program instructions to decimate or refine terrain and obstacle data resolution to match maneuver manifold resolution.

20. The object avoidance system of claim 11, further comprises at least one of an onboard terrain and obstacle database or an offboard server in communication with the processors.

21. A computer program product for object avoidance, the computer program product comprising:
a non-volatile computer readable storage medium having program instructions embodied therewith, the program instructions executable by a number of processors to cause the computer to perform the steps of:
receiving time-referenced position and state data for vehicles, including a control vehicle, within a specified time-space zone, wherein the vehicles have initial positions within the specified time-space zone;
receiving terrain and obstacle data for a spatial zone of interest, wherein a portion of the spatial zone of interest overlaps with a portion of the specified time-space zone;
calculating a probabilistic trajectory window for each vehicle within the specified time-space zone;
calculating spatial buffer zones around terrain and obstacles in the spatial zone of interest according to terrain and obstacle data uncertainty and resolution;
calculating a number of homotopically distinct paths for the control vehicle from a time-referenced initial position to a destination point, wherein the paths keep the control vehicle at least a minimum specified distance from the trajectory windows of other vehicles and the buffer zones of terrain and obstacles; and
routing the control vehicle according to one of the paths.

22. The computer program product of claim 21, wherein the homotopically distinct paths are calculated according to maneuver capabilities and constraints of the control vehicle.

23. The computer program product of claim 21, wherein the processors further perform the steps of:
calculating a number of new homotopically distinct paths in response to either changes in position and state data of other vehicles or changes in terrain and obstacle data; and
rerouting the control vehicle along one of the new paths.

24. The computer program product of claim 21, wherein the terrain and obstacle data are represented in a triangulated format.

25. The computer program product of claim 24, wherein the terrain and obstacle data comprise elevation data at regularly-spaced grid points.

26. The computer program product of claim 21 wherein the processors further perform the steps of displaying the homotopically distinct paths on a four-dimensional virtual predictive radar (4D-VPR).

27. The computer program product of claim 26, wherein the 4D-VPR indicates intersections of vehicles, terrain, and obstacles on time rings.

28. The computer program product of claim 21, wherein the processors further perform the steps of:
generating a space partition; and
mapping a maneuver manifold for the control vehicle into the space partition.

29. The computer program product of claim 21 wherein the processors further perform the steps of decimating or refining terrain and obstacle data resolution to match maneuver manifold resolution.

30. The computer program product of claim 21, wherein the terrain and obstacle data are provided by at least one of a database onboard the control vehicles or an offboard server.
